(19) United States
(12) Patent Application Publication
(10) Pub. No.: US 2022/0105705 A1
(43) Pub. Date: Apr. 7, 2022

(54) Washable Floor Mat With Reinforcement Layer

(71) Applicant: Milliken & Company, Spartanburg, SC (US)

(72) Inventors: Padmakumar Puthillath, Greer, SC (US); Mark Holbrook, Ramsbottom (GB); Ty G. Dawson, Spartanburg, SC (US); Daniel T. McBride, Chesnee, SC (US); Kirkland W. Vogt, Simpsonville, SC (US); Franklin S. Love, Columbus, NC (US); Dale S. Kitchen, Boiling Springs, SC (US)

(73) Assignee: Milliken & Company, Spartanburg, SC (US)

(21) Appl. No.: 17/551,272

(22) Filed: Dec. 15, 2021

Related U.S. Application Data
(62) Division of application No. 15/908,955, filed on Mar. 1, 2018.
(60) Provisional application No. 62/482,733, filed on Apr. 7, 2017.

(51) Int. Cl. B32B 7/06; A47G 27/02; A47L 23/26; B32B 5/12; B32B 25/04; D06N 7/00; B32B 5/02; B32B 5/06

(52) U.S. Cl. CPC B32B 7/06; D06N 2213/068; A47L 23/266; B32B 5/12; B32B 25/04; D06N 7/0055; B32B 5/02; B32B 5/06; D06N 7/0081; D06N 7/0036; B32B 2471/04; B32B 2307/208; B32B 2307/308; B32B 2307/734; D06N 2209/045; D06N 2205/10; D06N 2213/065; A47G 27/025

(57) ABSTRACT

This invention relates to a washable floor mat comprising a reinforcement layer. The floor mat includes a textile component and a base component. The textile component contains a reinforcement layer which dramatically reduces and/or eliminates edge deformation that often occurs as a result of the washing process. The textile component and the base component may be joined together to form a single piece floor mat. Alternatively, the textile component and the base component may be releasably attachable to one another by at least one surface attraction means to form a multi-component floor mat. The floor mat is designed to be soiled, washed, and re-used, thereby providing ideal end-use applications in areas such as building entryways.

### CROSS REFERENCE TO RELATED APPLICATION

This application claims priority to and is a divisional of U.S. patent application Ser. No. 15/908,955, entitled “Washable Floor Mat with Reinforcement Layer” which was filed on Mar. 1, 2018, which is a non-provisional of and claims priority to U.S. Provisional Patent Application No. 62/482,733, entitled “Washable Floor Mat with Reinforcement Layer” which was filed on Apr. 7, 2017, all of which are entirely incorporated by reference herein.

### TECHNICAL FIELD

This invention relates to a washable floor mat comprising a reinforcement layer. The floor mat includes a textile component and a base component. The textile component contains a reinforcement layer which dramatically reduces and/or eliminates edge deformation that often occurs as a result of the washing process. The textile component and the base component may be joined together to form a single piece floor mat. Alternatively, the textile component and the base component may be releasably attachable to one another by at least one surface attraction means to form a multi-component floor mat. The floor mat is designed to be soiled, washed, and re-used, thereby providing ideal end-use applications in areas such as building entryways.

### BACKGROUND

High traffic areas, such as entrances to buildings, restrooms, break areas, etc., typically have the highest floorcovering soiling issue. Therefore, floor mats are installed in these areas to collect dirt and liquid that might otherwise cause the appearance of the surrounding area to become less attractive over time. Collection of water by the floor mats also aids in the elimination of slippery floors, which can be a safety hazard.

These entryway floor mats undergo laundering on a regular basis in order to clean the soiled floor mats. Laundering may occur in both residential and commercial/industrial laundering facilities. During the laundering process, the textile component of the floor mat is typically exposed to physical stretching and/or compressing and high temperatures (e.g. >150° C.) which results in the problem of permanent deformation of the floor mat. At high temperatures, dimensional changes occur to the fibers comprising the floor mat, especially to synthetic fibers. Deformation includes the creation of ripples or waves, which tends to be most visible along the edges of the floor mat.

The present invention provides a solution to the problem of floor mat deformation via the incorporation of a reinforcement layer into the textile component. The reinforcement layer provides additional stability to the floor mat during the laundering process, thereby reducing the amount of physical force acting on the floor mat. The resulting reinforced, laundered floor mat exhibits little to no rippling or waviness, as observed by the human eye. Thus, the reinforced, washable floor mat of the present invention is an improvement over prior art floor mats.

### BRIEF SUMMARY

In one aspect, the invention relates to a multi-component floor mat comprising: (a) a textile component having a floor-facing surface and a non-floor facing surface, said textile component comprising: (i) a layer of tufted pile carpet formed by tufting face fibers through a primary backing layer, (ii) a reinforcement layer, wherein the reinforcement layer includes at least one of a textile substrate and an elastomeric material, and (iii) at least one surface attachment means; and (b) a base component, wherein the base component contains at least one surface attachment means; and wherein the textile component and the base component are releasably attachable to one another via the at least one surface attachment means.

In another aspect, the invention relates to a multi-component floor mat comprising: (a) a textile component having a floor-facing surface and a non-floor facing surface, said textile component comprising: (i) a layer of tufted pile carpet formed by tufting face fibers through a primary backing layer, (ii) a reinforcement layer, wherein the reinforcement layer includes at least one of a textile substrate and an elastomeric material, and (iii) a layer of vulcanized rubber material that contains magnetic particles; and (b) a base component comprised of (i) vulcanized rubber that contains magnetic particles or (ii) vulcanized rubber having a magnetic coating applied thereto; and wherein the textile component and the base component are releasably attachable to one another via magnetic attraction.

In a further aspect, the invention relates to a lightweight, single-piece floor mat comprising: (a) a textile component having a floor-facing surface and a non-floor facing surface, said textile component comprising: (i) a layer of tufted pile carpet formed by tufting face fibers through a primary backing layer, and (ii) a reinforcement layer, wherein the reinforcement layer includes at least one of a textile substrate and an elastomeric material; and (b) a base component comprised of elastomeric material; and wherein the textile component and the base component are permanently attached to one another; and wherein the single-piece floor mat can withstand at least one wash cycle in a commercial or residential washing machine and is suitable for re-use after exposure to the at least one wash cycle.

### BRIEF DESCRIPTION OF THE DRAWINGS

FIG. 1 illustrates the rippling effect that occurs as a result of the laundering process in prior art floor mats.

FIG. 2A is an expanded side view of the textile component of the floor mat of the present invention comprising a tufted pile carpet layer with a primary backing layer, a reinforcement layer, and a surface attachment means.

FIG. 2B is another expanded side view of the textile component of the floor mat of the present invention comprising a tufted pile carpet layer with a primary backing layer, a reinforcement layer, and a surface attachment means.

FIG. 2C is an expanded side view of a floor mat of the present invention comprising a textile component with a primary backing layer and a reinforcement layer and a base component.

FIG. 2D is an expanded side view of a floor mat of the present invention comprising a textile component with a primary backing layer, a reinforcement layer, and a surface attachment means and a base component.

FIG. 2E is a top perspective view of one embodiment of the base component of the floor mat.

FIG. 2F is a top perspective view of one embodiment of the floor mat of the present invention with the textile component partially pulled back from the recessed area of a base component.

FIG. 2G is a top perspective view of another embodiment of the floor mat of the present invention with the textile component and a flat (no recessed area) base component.

FIG. 2H is a top perspective view of the floor mat of FIG. 2G with the textile component partially pulled back from the flat (no recessed area) base component.

FIG. 3A is an expanded side view of another embodiment of the textile component of the floor mat of the present invention comprising a tufted pile carpet layer with a primary backing layer, a reinforcement layer, and a surface attachment means.

FIG. 3B is an expanded side view of another embodiment of the textile component of the floor mat of the present invention comprising a tufted pile carpet layer with a primary backing layer, a reinforcement layer, and a surface attachment means.

FIG. 3C is an expanded side view of another embodiment of a floor mat of the present invention comprising a textile component with a primary backing layer and a reinforcement layer and a base component.

FIG. 3D is an expanded side view of another embodiment of a floor mat of the present invention comprising a textile component with a primary backing layer, a reinforcement layer, and a surface attachment means and a base component.

FIG. 3E illustrates schematically an embodiment of the textile component comprised of the reinforcement layer in strip form attached to the primary backing layer.

FIG. 3F is an angled view of an embodiment of the textile component comprised of the reinforcement layer in strip form attached the primary backing layer.

FIG. 4 is a graph illustrating the load-strain curves of Examples 1 and 2 and Comparative Example 1.

### DETAILED DESCRIPTION

The present invention described herein is a washable floor mat with a reinforcement layer. The floor mat is comprised of a textile component and a base component. The textile component of the floor mat contains a primary backing layer and a reinforcement layer. In one aspect of the invention, the reinforcement layer is present in a configuration that covers the entire surface area of the textile component. In a further aspect, the reinforcement layer is present in a configuration that covers only the edges (e.g. border area) of the textile component. In this aspect of the invention, the floor mat has a physical border reinforcement provided by the reinforcement layer. The textile component and the base component may be joined together to form a single-piece floor mat containing the reinforcement layer. Alternatively, the floor mat may be a multi-component floor mat wherein the textile component and the base component are releasably attached to one another. In one aspect, the textile component and the base component may be releasably attached to one another via magnet attraction. The inventive floor mat contains a physical reinforcement layer that results in a stronger, tufted textile-rubber composite that exhibits a flatter, planar configuration after laundering.

The base component of the floor mat may be partially or wholly covered with a textile component. Typically, the textile component will be lighter in weight than the base component. Inversely, the base component will weigh more than the textile component.

The textile component and the base component may be releasably attachable to one another via at least one surface attachment means. Surface attachment means include magnetic attraction (such as magnetic coatings, magnetic particles dispersed within a rubber or binder material, spot magnets, and the like), mechanical attachment (such as Velcro® fastening systems, mushroom-shaped protrusions, grommets, and the like), adhesive attraction (such as cohesive materials, silicone materials, and the like), and combinations thereof.

The surface attachment means may be in the form of a coating (such as a magnetic coating), or it may be in the form of discrete attachment mechanisms (such as spot magnets or non-uniform areas of surface attachment means). In one aspect, discrete attachment mechanisms include individual patches of mechanical attachment means. For example, individual patches of Velcro® fastening systems or mushroom-type hook fastening systems may be attached to the textile and base components in a uniform or non-uniform arrangement. For instance, a 1″×1″ Velcro® patch on a 10″×10″ grid may be applied to the textile and base components. Suitable surface attachment means are described, for example, in commonly-owned U.S. Patent Application Publication Nos. 2017/0037567 and 2017/0037568.

In another aspect of the invention, the textile component and the base component may include an edge attachment means. The edge attachment means may be used in combination with the surface attachment means, or it may be used without a surface attachment means (i.e. free from surface attachment means). Edge attachment means include, for example, hook and loop fastening systems (such as Velcro® fasteners), mushroom-type hook fastening systems (such as Dual Lock™ fasteners from 3M), and the like, and combinations thereof.

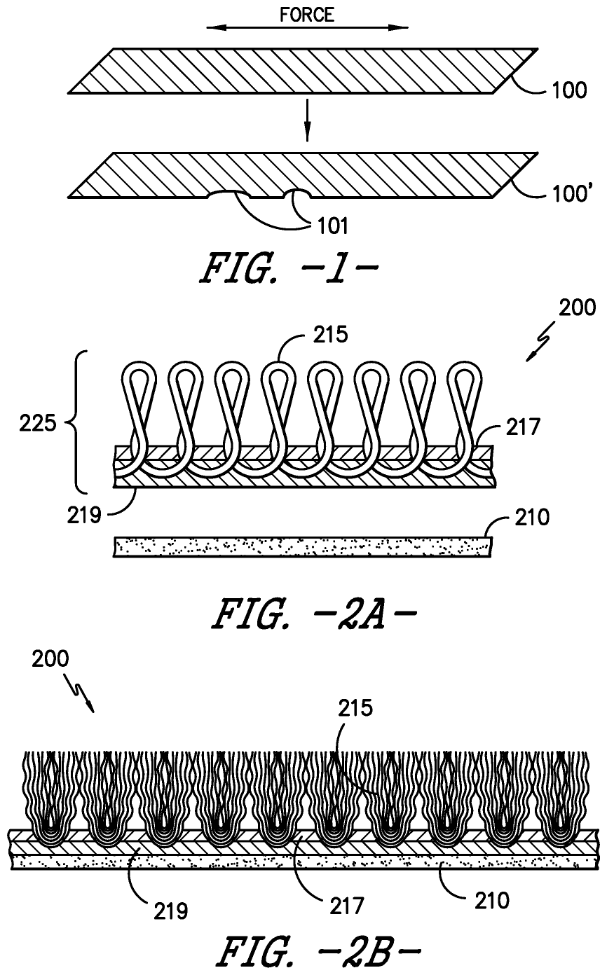

Referring now to the Figures, FIG. 1 illustrates deformation that occurs as a result of the laundering process. Textile component 100 is shown schematically prior to being subjected to force (such as from exposure to a laundering cycle) and therefore having no deformation. Textile component 100′ is shown schematically after being subjected to force, such as that encountered during a laundering cycle. Textile component 100′ contains ripples 101.

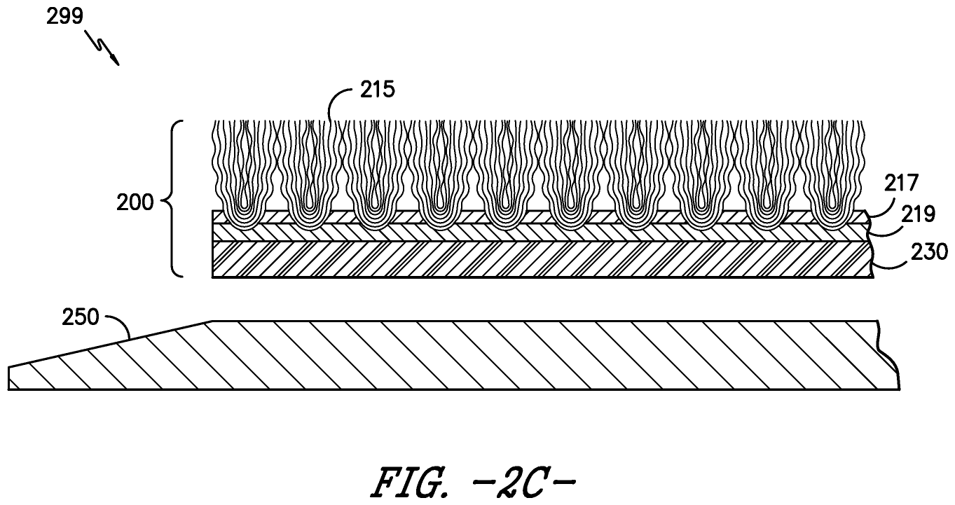

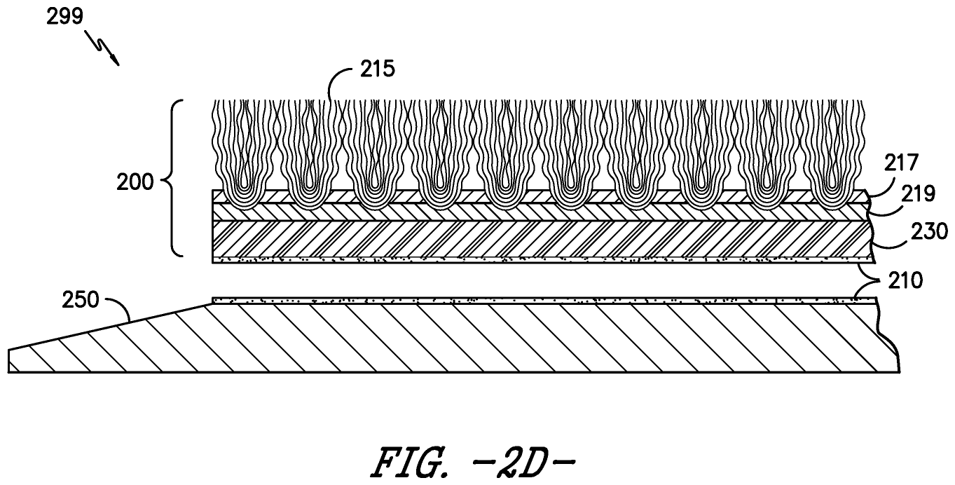

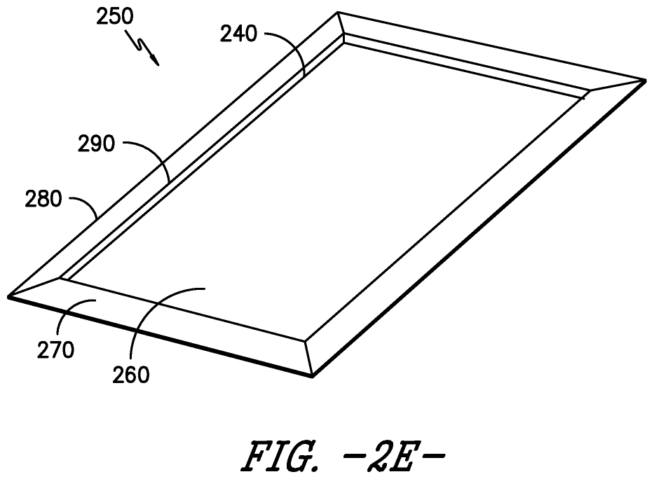

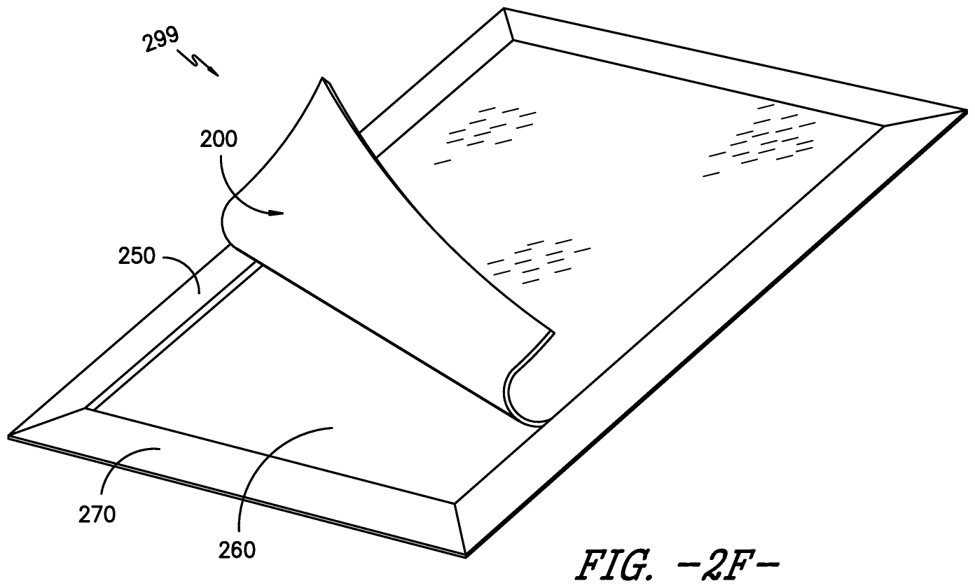

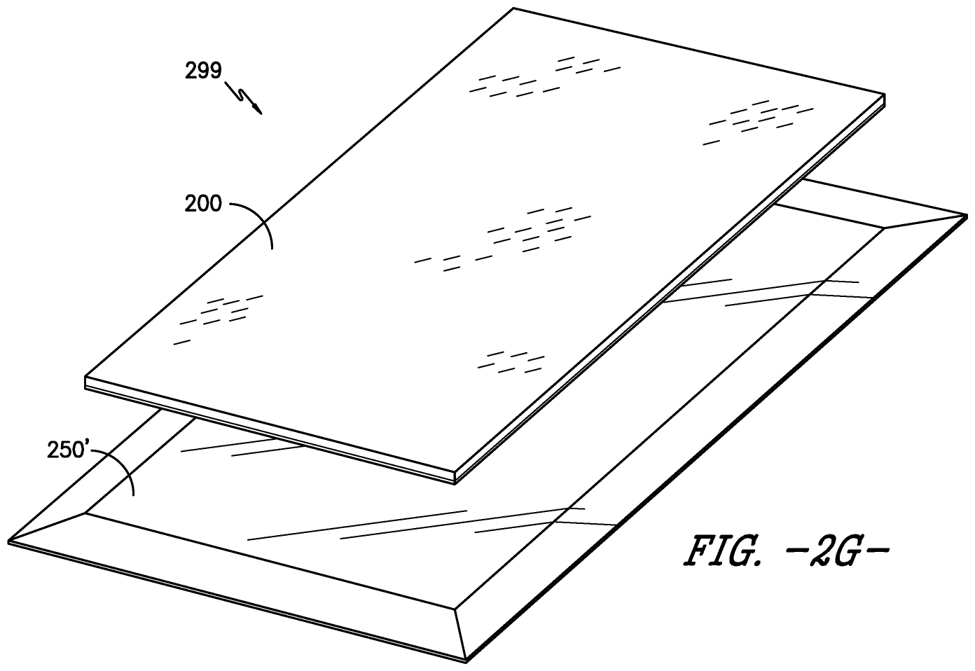

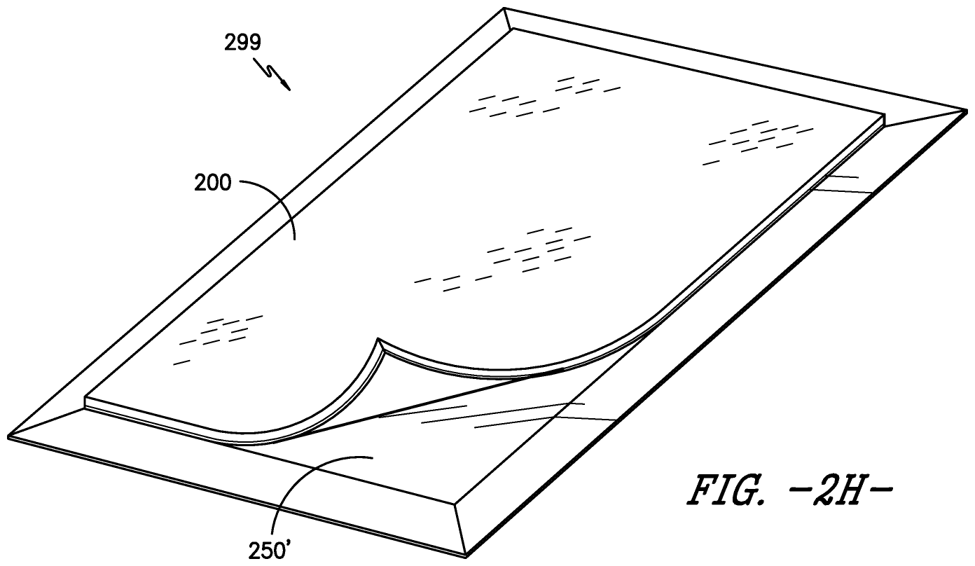

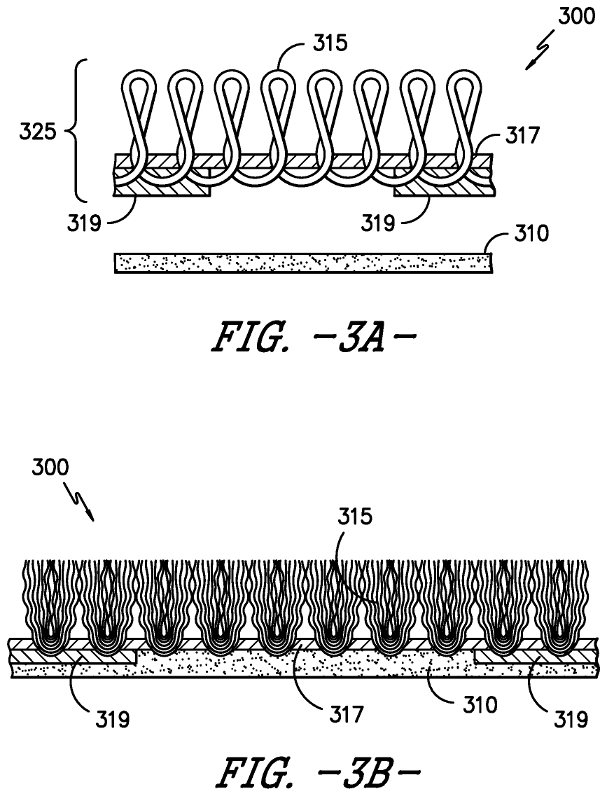

FIG. 2A illustrates textile component 200 comprised of tufted pile carpet 225. Tufted pile carpet 225 is comprised of primary backing layer 217, reinforcement layer 219, and face yarns 215. Primary backing layer 217 provides stability to face yarns 215. Reinforcement layer 219 may also provide additional stability to face yarns 215. Reinforcement layer 219 also greatly reduces and/or eliminates the rippling that is often observed along the border and/or edges of the prior art floor mats. In this embodiment, reinforcement layer 219 is shown as a continuous layer attached to the surface of primary backing layer 217, said surface being the surface that faces away from face yarns 215.

In one aspect of the invention, reinforcement layer 219 is comprised of a textile substrate. In this instance reinforcement layer 219 may be attached to primary backing layer 217 by needle punching, or by any other known methods for securing two textile substrates to one another (e.g. stitching). In one aspect, the process of securing the reinforcement layer to the primary backing layer results in at least a portion of one layer (e.g. fiber(s) or yarn(s) of the reinforcement layer) being located within at least a portion of the other layer (e.g. the primary backing layer). Herein, the fiber(s) and/or yarns(s) comprising the reinforcement layer and the primary backing layer may be considered to be commingled. The process of securing the reinforcement layer to the primary backing layer may occur either before or after the tufting process.

The materials comprising face yarns 215 and primary backing layer 217 are independently selected from synthetic fiber, natural fiber, man-made fiber using natural constituents, inorganic fiber, glass fiber, and a blend of any of the foregoing. By way of example only, synthetic fibers may include polyester, acrylic, polyamide, polyolefin, polyaramid, polyurethane, or blends thereof. More specifically, polyester may include polyethylene terephthalate, polytrimethylene terephthalate, polybutylene terephthalate, polylactic acid, or combinations thereof. Polyamide may include nylon 6, nylon 6,6, or combinations thereof. Polyolefin may include polypropylene, polyethylene, or combinations thereof. Polyaramid may include poly-p-phenyleneteraphthalamide (i.e., Kevlar®), poly-m-phenyleneteraphthalamide (i.e., Nomex®), or combinations thereof. Exemplary natural fibers include wool, cotton, linen, ramie, jute, flax, silk, hemp, or blends thereof. Exemplary man-made materials using natural constituents include regenerated cellulose (i.e., rayon), lyocell, or blends thereof.

The material comprising face yarns 215 and primary backing layer 217 may be independently formed from staple fiber, filament fiber, slit film fiber, or combinations thereof. The fiber may be exposed to one or more texturing processes. The fiber may then be spun or otherwise combined into yarns, for example, by ring spinning, open-end spinning, air jet spinning, vortex spinning, or combinations thereof. Accordingly, the material comprising face yarns 215 will generally be comprised of interlaced fibers, interlaced yarns, loops, or combinations thereof.

The material comprising face yarns 215 and primary backing layer 217 may be independently comprised of fibers or yarns of any size, including microdenier fibers or yarns (fibers or yarns having less than one denier per filament). The fibers or yarns may have deniers that range from less than about 0.1 denier per filament to about 2000 denier per filament or, more preferably, from less than about 1 denier per filament to about 500 denier per filament.

Furthermore, the material comprising face yarns 215 and primary backing layer 217 may be independently partially or wholly comprised of multi-component or bi-component fibers or yarns in various configurations such as, for example, islands-in-the-sea, core and sheath, side-by-side, or pie configurations. Depending on the configuration of the bi-component or multi-component fibers or yarns, the fibers or yarns may be splittable along their length by chemical or mechanical action.

Additionally, face yarns 215 and primary backing layer 217 may independently include additives coextruded therein, may be precoated with any number of different materials, including those listed in greater detail below, and/or may be dyed or colored to provide other aesthetic features for the end user with any type of colorant, such as, for example, poly(oxyalkylenated) colorants, as well as pigments, dyes, tints, and the like. Other additives may also be present on and/or within the target fiber or yarn, including antistatic agents, brightening compounds, nucleating agents, antioxidants, UV stabilizers, fillers, permanent press finishes, softeners, lubricants, curing accelerators, and the like.

The face yarns 215 may be dyed or undyed. If the face yarns 215 are dyed, they may be solution dyed. The weight of the face yarn, pile height, and density will vary depending on the desired aesthetics and performance requirements of the end-use for the floor mat. In FIG. 2A, face yarns 215 are illustrated in a loop pile construction. Looking to FIG. 2B, textile component 200 is shown with face yarns 215 in a cut pile construction. Of course, it is to be understood that face yarn constructions including combinations of loop pile and cut pile may likewise be used.

The primary backing layer can be any suitable primary backing material. The primary backing layer may be comprised of a woven, nonwoven or knitted material, or combinations thereof. The general purpose of the primary backing layer is to support the tufts of the face fibers. In one aspect, the primary backing layer is a nonwoven polyester spunbond material. One commercially available example of the polyester spunbond material is Lutradur® from Freudenberg Nonwovens of Weinheim, Germany. In another aspect, flat woven polyester tapes, such as Artis® from Propex of Chattanooga, Tenn., may be utilized. Also, Colback® nonwoven backing material may also be suitable for use. If needed, a primary backing layer made of a woven tape with either staple fibers or nonwoven fabrics affixed can be used. Also, stitch bonded and knitted polyester fabrics may be used.

The reinforcement layer of the present invention is comprised of any material of sufficient strength and integrity to reduce and/or eliminate physical deformation of the floor mat. In one aspect, the reinforcement layer may be comprised of any suitable fibrous material that aids in reducing and/or eliminating the rippling effect that occurs in the textile component of the floor mat. For example, the reinforcement layer may be comprised of a knit, woven or non-woven textile substrate. The reinforcement layer may be comprised of a unidirectional or a bidirectional textile substrate. The reinforcement layer may further include a rubber material. In this aspect, the reinforcement layer is comprised of at least one fibrous material and at least one elastomeric material. The combination of fibrous and elastomeric materials forming the reinforcement layer is referred to herein as a fiber-elastomeric composite, or even a textile-rubber composite. Examples of suitable elastomeric materials for forming the reinforcement layer are elastomeric materials (such as natural and synthetic rubber materials and polyurethane materials and mixtures thereof), thermoplastic and thermoset resins and metal. The rubber material may be selected from the group consisting of nitrile rubber, including dense nitrile rubber, foam nitrile rubber, and mixtures thereof; polyvinyl chloride rubber; ethylene propylene diene monomer (EPDM) rubber; vinyl rubber; thermoplastic elastomer; polyurethane elastomer; and mixtures thereof. The rubber material may contain from 0% to 40% of a recycled rubber material. The elastomeric material of the reinforcement layer may be the same material as that forming the base component. Alternatively, the elastomeric material of the reinforcement layer may be a different material than that forming the base component.

Referring back to FIG. 2A, the tufted pile carpet 225 that includes face yarns tufted into a primary backing layer may be heat stabilized to prevent dimensional changes from occurring in the finished mat. The heat stabilizing or heat setting process typically involves applying heat to the material that is above the glass transition temperature, but below the melting temperature of the components. The heat allows the polymer components to release internal tensions and allows improvement in the internal structural order of the polymer chains. The heat stabilizing process can be carried out under tension or in a relaxed state. The tufted pile carpet is sometimes also stabilized to allow for the yarn and the primary backing layer to shrink prior to the mat assembly process.

The face yarns can be of any pile height and weight necessary to support printing. The tufted pile carpet may be printed using any print process. In one aspect, injection dyeing may be utilized to print the tufted pile carpet.

Printing inks will contain at least one dye. Dyes may be selected from acid dyes, direct dyes, reactive dyes, cationic dyes, disperse dyes, and mixtures thereof. Acid dyes include azo, anthraquinone, triphenyl methane and xanthine types. Direct dyes include azo, stilbene, thiazole, dioxsazine and phthalocyanine types. Reactive dyes include azo, anthraquinone and phthalocyanine types. Cationic dyes include thiazole, methane, cyanine, quinolone, xanthene, azine, and triaryl methine. Disperse dyes include azo, anthraquinone, nitrodiphenylamine, naphthal imide, naphthoquinone imide and methane, triarylmethine and quinoline types.

As is known in the textile printing art, specific dye selection depends upon the type of fiber and/or fibers comprising the washable textile component that is being printed. For example, in general, a disperse dye may be used to print polyester fibers. Alternatively, for materials made from cationic dyeable polyester fiber, cationic dyes may be used.

The printing process of the present invention uses a jet dyeing machine, or a digital printing machine, to place printing ink on the surface of the mat in predetermined locations. One suitable and commercially available digital printing machine is the Millitron® digital printing machine, available from Milliken & Company of Spartanburg, S.C. The Millitron® machine uses an array of jets with continuous streams of dye liquor that can be deflected by a controlled air jet. The array of jets, or gun bars, is typically stationary. Another suitable and commercially available digital printing machine is the Chromojet® carpet printing machine, available from Zimmer Machinery Corporation of Spartanburg, S.C. In one aspect, a tufted carpet made according to the processes disclosed in U.S. Pat. Nos. 7,678,159 and 7,846,214, both to Weiner, may be printed with a jet dyeing apparatus as described and exemplified herein.

Viscosity modifiers may be included in the printing ink compositions. Suitable viscosity modifiers that may be utilized include known natural water-soluble polymers such as polysaccharides, such as starch substances derived from corn and wheat, gum arabic, locust bean gum, tragacanth gum, guar gum, guar flour, polygalactomannan gum, xanthan, alginates, and a tamarind seed; protein substances such as gelatin and casein; tannin substances; and lignin substances. Examples of the water-soluble polymer further include synthetic polymers such as known polyvinyl alcohol compounds and polyethylene oxide compounds. Mixtures of the aforementioned viscosity modifiers may also be used. The polymer viscosity is measured at elevated temperatures when the polymer is in the molten state. For example, viscosity may be measured in units of centipoise at elevated temperatures, using a Brookfield Thermosel unit from Brookfield Engineering Laboratories of Middleboro, Mass. Alternatively, polymer viscosity may be measured by using a parallel plate rheometer, such as made by Haake from Rheology Services of Victoria Australia.

In one aspect of the invention, the height of the finished textile component will be substantially the same height as the surrounding base component when the base component is provided in a tray configuration. Any layers of elastomeric material (e.g. rubber material) that are added as part of the textile component (e.g. the reinforcement layer) will be vulcanized according to methods known those skilled in the art. Once vulcanized, the textile component may be pre-shrunk by washing.

As also shown in FIGS. 2A and 2B, the textile component 200 may further comprise a magnetic coating layer 210. The magnetic coating layer 210 is present on the surface of the textile component 200 that is opposite face yarns 215. Application of magnetic coating layer 210 to the tufted pile carpet 225 will be described in greater detail below. The resulting textile component 200 is wash durable and exhibits sufficient tuft lock for normal end-use applications. In one alternative embodiment of the invention, the textile component may be a disposable textile component that is removed and disposed of or recycled and then replaced with a new textile component for attachment to the base component.

After the textile component has been made, it will be custom cut to fit into the recessed area of the base component (for instances in which the base component is in the form of a tray) or onto the base component (for instances wherein the base component is substantially flat/trayless/without recessed area). The textile component may be cut using a computer controlled cutting device, such as a Gerber machine. It may also be cut using a mechanical dye cutter, hot knife, straight blade, or rotary blade. In one aspect of the invention, the thickness of the textile component will be substantially the same as the depth of the recessed area when the base component is in the form of a tray.

FIG. 2C illustrates a multi-component floor mat 299 comprised of a textile component 200 and a base component 250. Textile component 200 is comprised of face fibers 215 tufted through primary backing layer 217 and reinforcement layer 219. An optional secondary backing layer 230 comprised of vulcanized rubber may also be included. FIG. 2D illustrates a multi-component floor mat 299 comprised of a textile component 200 and a base component 250. Textile component 200 is comprised of face fibers 215 tufted through primary backing layer 217 and reinforcement layer 219. An optional secondary backing layer 230 comprised of vulcanized rubber may also be included. The textile component 200 further includes a magnetic coating 210. A magnetic coating 210 may also be added to base component 250. Application of magnetic coating layer 210 to the textile and base components will be described in greater detail below. The resulting textile component 200 is wash durable, exhibits sufficient tuft lock for normal end-use applications, and reduces and/or eliminates rippling.

FIG. 2E illustrates one embodiment of the base component of the floor mat of the present invention. Referring to FIG. 2E, base component 250 contains recessed area 260 surrounded by border 270. Border 270 slopes gradually upward from outer perimeter 280 to inner perimeter 290, to create recess 240 within base 250, corresponding to the recessed area of 260. FIG. 2E illustrates that the recessed area 260 of base component 250 possesses a certain amount of depth, thereby defining it as “recessed.” The depth of recessed area 260 is illustrated by 240.

As shown in FIG. 2E, the base component is a planar-shaped tray, which is sized to accommodate the textile component. The base component may also include a border surrounding the tray, whereby the border provides greater dimensional stability to the tray, for example, because the border is thicker, i.e. greater in height relative to the floor. Additionally, the border may be angled upward from its outer perimeter towards the interior of the base component, so as to provide a recessed area where the tray is located, thereby creating a substantially level area between the inner perimeter of the border and the textile component, when the textile component overlays the tray. Additionally, the gradual incline from the outer perimeter of the border to the inner perimeter of the border minimizes tripping hazards and the recess created thereby protects the edges of the textile component.

It can be understood that the base component may be subdivided into two or more recessed trays, by extending a divider from one side of the border to an opposite side of the border, substantially at the height of the inner perimeter. Accordingly, it would be possible to overlay two or more textile components in the recesses created in the base component.

The base component, including the border, may be formed in a single molding process as a unitary article. Alternatively, the border and the tray may be molded separately and then bonded together in a second operation. The tray and border may be made of the same or different materials. Examples of suitable compositions for forming the border and the tray are elastomeric materials (such as natural and synthetic rubber materials and polyurethane materials and mixtures thereof), thermoplastic and thermoset resins and metal. The rubber material may be selected from the group consisting of nitrile rubber, including dense nitrile rubber, foam nitrile rubber, and mixtures thereof; polyvinyl chloride rubber; ethylene propylene diene monomer (EPDM) rubber; vinyl rubber; thermoplastic elastomer; polyurethane elastomer; and mixtures thereof. In one aspect, the base component is typically comprised of at least one rubber material. The rubber material may contain from 0% to 40% of a recycled rubber material.

In one aspect, the base component may be formed into a tray shape according to the following procedure. Rubber strips are placed overlapping the edges of a metal plate. The metal plate is to be placed on top of a sheet rubber and covered on all 4 sides by strip rubber. As the mat is pressed, it will bond the sheet rubber to the strips. This process may be completed, for example, at a temperature of 370° F. and a pressure of 36 psi. However, depending upon the rubber materials selected, the temperature may be in the range from 200° F. to 500° F. and the pressure may be in the range from 10 psi to 50 psi. Using the recommend settings, the mat may be completely cured in 8 minutes. After the rubber strips are bound to the rubber sheet, the metal plate is removed leaving a void (i.e. a recessed area in the base component) in which to place the textile component. The textile component has the ability to be inserted and removed from the base component multiple times.

As seen in FIG. 2F, floor mat 299 is present in an arrangement wherein textile component 200 overlays recessed area 260 of base component 250. A corner of textile component 200 is turned back to further illustrate how the two components fit together within border 270.

As previously discussed herein, the base component of the floor mat may be in the form a tray. However, in one alternative embodiment, the base component of the floor mat may be flat and have no recessed area (i.e. the base component is trayless). A flat base component is manufactured from a sheet of material, such as a rubber material, that has been cut in the desired shape and vulcanized.

FIG. 2G illustrates a multi-component floor mat 299 wherein textile component 200 is combined with base component 250′ that is flat and has no recessed area (i.e. trayless). FIG. 2H shows the multi-component floor mat 299 wherein both textile component 200 and base component 250′ are assembled together, with a corner of textile component 200 turned back to further illustrate how the two components fit together.

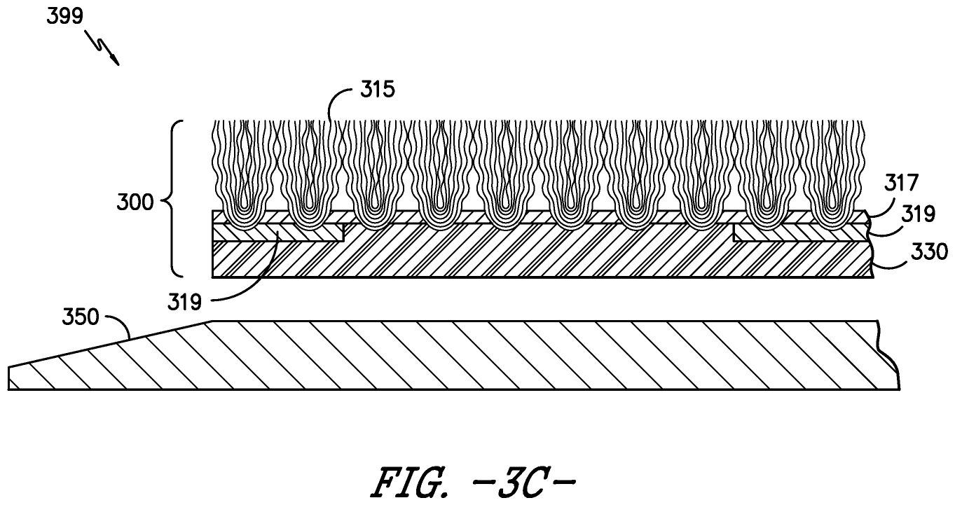

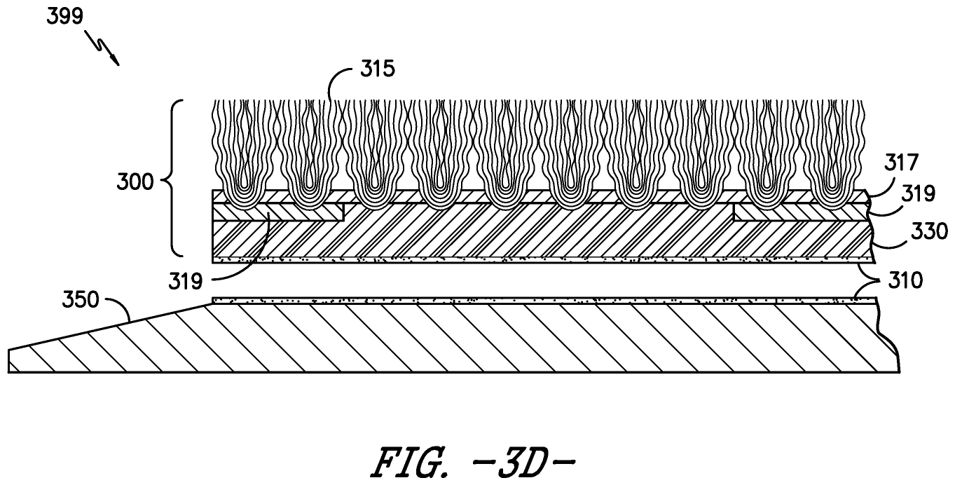

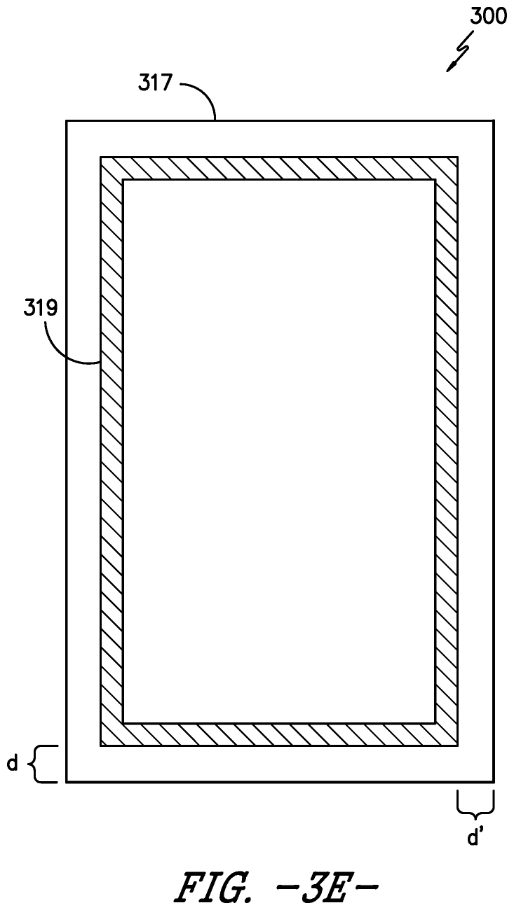

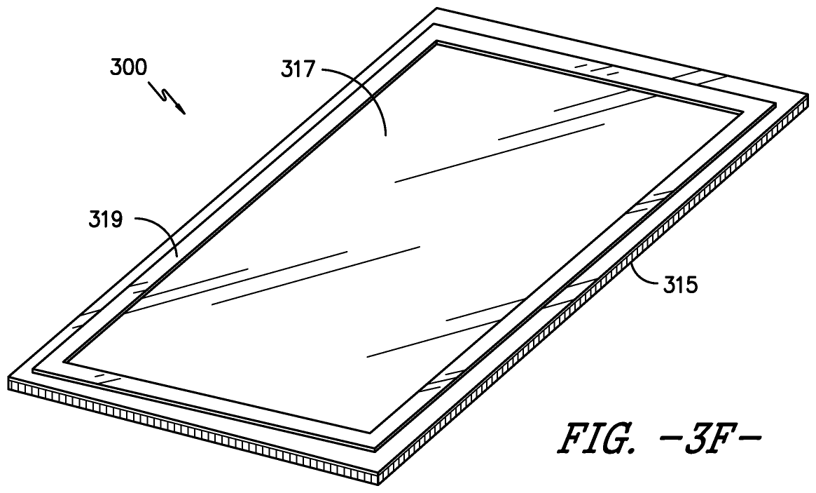

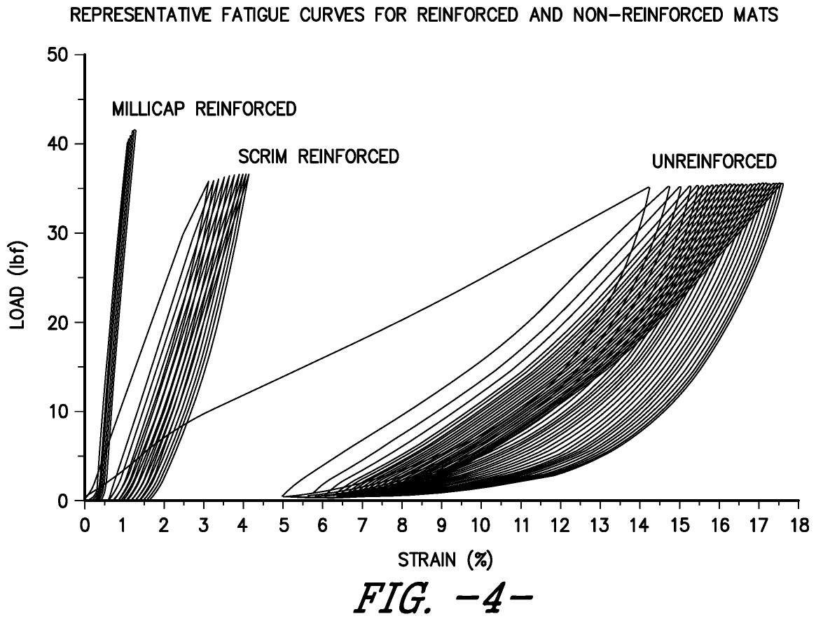

FIG. 3A illustrates reinforcement layer 319 attached to the surface of primary backing layer 317, said surface being the surface that faces away from face yarns 315. In this embodiment, reinforcement layer 319 is a non-continuous layer. More specifically, in this embodiment, reinforcement layer 319 is shown as being present on only the edges (or border areas) of textile component 300. Thus, tufted pile carpet 325 contains face yarns 315, primary backing layer 317 and reinforcement layer 319. Looking to FIG. 3B, textile component 300 is shown with face yarns 315 in a cut pile construction. Of course, it is to be understood that face yarn constructions including combinations of loop pile and cut pile may likewise be used.

As also shown in FIGS. 3A and 3B, the textile component 300 may further comprise a magnetic coating layer 310. The magnetic coating layer 310 is present on the surface of reinforcement layer 319, said surface being the surface that faces away from face yarns 315. Application of magnetic coating layer 310 to the tufted pile carpet 325 will be described in greater detail below. The resulting textile component 300 is wash durable and exhibits sufficient tuft lock for normal end-use applications. In one alternative embodiment of the invention, the textile component may be a disposable textile component that is removed and disposed of or recycled and then replaced with a new textile component for attachment to the base component.

FIG. 3C illustrates a multi-component floor mat 399 comprised of a textile component 300 and a base component 350. Textile component 300 is comprised of face fibers 315 tufted through primary backing layer 317 and reinforcement layer 319. As shown in FIG. 3C, reinforcement layer 319 is non-continuous. An optional secondary backing layer 330 comprised of vulcanized rubber may also be included. FIG. 3D illustrates a multi-component floor mat 399 comprised of a textile component 300 and a base component 350. Textile component 300 is comprised of face fibers 315 tufted through primary backing layer 317 and reinforcement layer 319. Again, reinforcement layer 319 is non-continuous. An optional secondary backing layer 330 comprised of vulcanized rubber may also be included. The textile component 300 further includes a magnetic coating 310. A magnetic coating 310 may also be added to base component 350. Application of magnetic coating layer 310 to the textile and base components will be described in greater detail below. The resulting textile component 300 is wash durable, exhibits sufficient tuft lock for normal end-use applications, and reduces and/or eliminates rippling.

FIG. 3E shows textile component 300 comprised of primary backing layer 317 and reinforcement layer 319. In this embodiment, reinforcement layer 319 is shown in a picture frame-type configuration. Reinforcement layer 319 is provided in strip form at a distance “d” and “d′” (d prime) from the edge of primary backing layer 317. In the picture frame-type embodiment, the numerical value of distance “d” and “d′” is always greater than zero. However, in other embodiments of the present invention, at least one of “d” and “d′” is greater than zero, or both “d” and “d′” may be equal to zero. The numerical value of distance “d” and “d′” may be the same, or the numerical value of distance “d” and “d′” may be different. In this embodiment, the viewer is looking at the intended floor-facing surface of textile component 300.

FIG. 3F shows reinforcement layer 319 having a raised surface over primary backing layer 317. It again illustrates distance “d” and “d′” in relation to the edge of primary backing layer 317 and the location of reinforcement layer 319. FIG. 3F further illustrates this view of textile component 300 by showing the location of face yarns 315. In this embodiment, the viewer is looking at the intended floor-facing surface of textile component 300 (but in an angled view).

In one aspect of the invention, the reinforcement layer is a woven textile substrate. Woven textile substrates include, for example, plain weave, satin weave, twill weave, basket-weave, poplin, jacquard, crepe weave textile substrates, and combinations thereof. Preferably, the woven textile substrate is a plain weave textile substrate. Plain weave textile substrates generally exhibit good abrasion and wear characteristics. Twill weave textile substrates generally exhibit ideal properties for compound curves, which makes these substrates potentially preferred for rubber-containing articles.

In another aspect, the reinforcement layer is a knit textile substrate. Knit textile substrates include, for example, circular knit fabrics, reverse plaited circular knit fabrics, double knit fabrics, single jersey knit fabrics, two-end fleece knit fabrics, three-end fleece knit fabrics, terry knit or double loop knit fabrics, weft inserted warp knit fabrics, warp knit fabrics, warp knit fabrics with or without a micro-denier face, and combinations thereof.

In another embodiment, the reinforcement layer is a multi-axial textile substrate, such as a tri-axial fabric (knit, woven, or non-woven). In another embodiment, the reinforcement layer is a bias fabric. In another embodiment, the reinforcement layer is a non-woven fabric. The term non-woven refers to structures incorporating a mass of yarns that are entangled and/or heat fused so as to provide a coordinated structure with a degree of internal coherency. Non-woven fabrics for use as the reinforcement layer may be formed from processes such as, for example, melt-spun processes, hydro-entangling processes, mechanical entangling processes, stitch-bonding, and the like, and combinations thereof.

In another embodiment, the reinforcement layer is a unidirectional fabric which may have overlapping fiber or may have gaps between the fibers. In one embodiment, a fiber is wrapped continuously around the rubber article to form the unidirectional reinforcement layer. In some embodiments, inducing spacing between the fibers may lead to slight rubber bleeding between the fibers which may be beneficial for adhesion purposes.

Floor mats of the present invention may be of any geometric shape or size as desired for its end-use application. The longitudinal edges of the floor mats may be of the same length and width, thus forming a square shape. Or, the longitudinal edges of the floor mats may have different dimensions such that the width and the length are not the same. Alternatively, the floor mats may be circular, hexagonal, and the like. As one non-limiting example, floor mats of the present invention may be manufactured into any of the current industry standards sizes that include 2 feet by 4 feet, 3 feet by 4 feet, 3 feet by 5 feet, 4 feet by 6 feet, 3 feet by 10 feet, and the like. In one aspect, the textile component and the base component have the same dimensions. In another aspect, the textile component and the base component have different dimensions. For example, the textile component may be smaller in size than the base component. In this example, at least a portion of the base component is visible in a top perspective view of the multi-component floor mat. Alternatively, the textile component may be larger in size than the base component. In this embodiment, none of the base component is visible in a top perspective view of the multi-component floor mat.

As described herein, in one aspect, the textile component and the base component may be held together, at least in part, by magnetic attraction. Magnetic attraction is achieved via application of a magnetic coating to the textile component and/or base component or via incorporation of magnetic particles in an elastomer-containing layer (e.g. rubber-containing layer) prior to vulcanization. Alternatively, magnetic attraction can be achieved using both methods such that a magnetic coating is applied to the textile component and magnetic particles are included in the vulcanized rubber of the base component. The inverse arrangement is also contemplated.

The magnetic coating may be applied to the textile component and/or the base component by several different manufacturing techniques. Exemplary coating techniques include, without limitation, knife coating, pad coating, paint coating, spray application, roll-on-roll methods, troweling methods, extrusion coating, foam coating, pattern coating, print coating, lamination, and mixtures thereof.

In instances wherein magnetic attraction is achieved by incorporating magnetic particles in an elastomer-containing layer, the following procedure may be utilized: (a) an unvulcanized elastomer-containing material is provided (such as nitrile, SBR, or EPDM rubber, or polyurethane elastomer), (b) magnetic particles are added to the material, (c) the particles are mixed with the material, and (d) the mixture of step “c” is formed into a sheet and attached to the bottom of the textile component and/or represents the base component. Mixing in step “c” may be achieved via a rubber mixing mill.

In this application, magnetizable is defined to mean the particles present in the coating or vulcanized rubber layer are permanently magnetized or can be magnetized permanently using external magnets or electromagnets. Once the particles are magnetized, they will keep their magnetic response permanently. The magnetizable behavior for generating permanent magnetism falls broadly under ferromagnets and ferrimagnets. Barium ferrites, strontium ferrites, neodymium and other rare earth metal based alloys are non-limiting examples of materials that can be applied in the magnetic coatings and/or vulcanized rubber layer.

As used herein, magnetically responsive is defined to mean the particles present in the coating and/or vulcanized rubber layer are only magnetically responsive in the presence of external magnets. The component that contains the magnetic particles is exposed to a magnetic field which aligns the dipoles of magnetic particles. Once the magnetic field is removed from the vicinity, the particles will become non-magnetic and the dipoles are no longer aligned. The magnetically responsive behavior or responsive magnetic behavior falls broadly under paramagnets or superparamagnets (particle size less than 50 nm).

This feature of materials being reversibly magnetic occurs when the dipoles of the superparamagnetic or paramagnetic materials are not aligned, but upon exposure to a magnet, the dipoles line up and point in the same direction thereby allowing the materials to exhibit magnetic properties. Non-limiting examples of materials exhibiting these features include iron oxide, steel, iron, nickel, aluminum, or alloys of any of the foregoing.

Further examples of magnetizable magnetic particles include BaFe₃O₄, SrFe₃O₄, NdFeB, AlNiCo, CoSm and other rare earth metal based alloys, and mixtures thereof. Examples of magnetically responsive particles include Fe₂O₃, Fe₃O₄, steel, iron particles, and mixtures thereof. The magnetically receptive particles may be paramagnetic or superparamagnetic. The magnet particles are typically characterized as being non-degradable.

In one aspect of the invention, particle size of the magnetically receptive particles is in the range from 1 micron to 50 microns, or in the range from 1 micron to 40 microns, or in the range from 1 micron to 30 microns, or in the range from 1 micron to 20 microns, or in the range from 1 micron to 10 microns. Particle size of the magnetically receptive particles may be in the range from 10 nm to 50 nm for superparamagnetic materials. Particle size of the magnetically receptive particles is typically greater than 100 nm for paramagnetic and/or ferromagnetic materials.

Magnetic attraction is typically exhibited at any loading of the above magnetic materials. However, the magnetic attraction increases as the loading of magnetic material increases. In one aspect of the invention, the magnetic field strength of the textile component to the base component is greater than 50 Gauss, more preferably greater than 100 Gauss, more preferably greater than 150 Gauss, or even more preferably greater than 200 Gauss.

In one aspect, the magnetic material is present in the coating composition in the range from 25% to 95% by weight of the coating composition. In another aspect, magnetic particle loading may be present in the magnetic coating applied to the textile component in the range from 10% to 70% by weight of the textile component. The magnetic particle loading may be present in the magnetic coating applied to the base component in the range from 10% to 90% by weight of the base component.

The magnetically receptive particles may be present in the vulcanized rubber layer of the textile component in a substantially uniform distribution. In another aspect of the present invention, it is contemplated that the magnetically receptive particles are present in the rubber layer of the textile component in a substantially non-uniform distribution. One example of a non-uniform distribution includes a functionally graded particle distribution wherein the concentration of particles is reduced at the surface of the textile component intended for attachment to the base component. Alternatively, another example of a non-uniform distribution includes a functionally graded particle distribution wherein the concentration of particles is increased at the surface of the textile component intended for attachment to the base component.

The amount of magnetic particles present in the textile component and in the base component of the floor mat may be approximately the same, or the amounts may be different. In one aspect, the amount of magnetic particles present in the base component is larger than the amount of magnetic particles present in the textile component. In one aspect of the invention, the amount of magnetic particles present in the base component is 10% larger by weight than the amount of magnetic particles present in the textile component, or even 20% larger by weight, or even 30% larger by weight than in the textile component.

The magnetic attraction between the textile component and the base component may be altered by manipulation of the surface area of one or both of the textile and/or base components. The surfaces of one or both of the components may be textured in such a way that surface area of the component is increased. Such manipulation may allow for customization of magnetic attraction that is not directly affected by the amount of magnetic particles present in the floor mat.

For instance, a substantially smooth (less surface area) bottom surface of the textile component will generally result in greater magnetic attraction to the top surface of the base component. In contrast, a less smooth (more surface area) bottom surface of the textile component (e.g. one having ripples or any other textured surface) will generally result in less magnetic attraction to the top surface of the base component. Of course, a reverse arrangement is also contemplated wherein the base component contains a textured surface. Furthermore, both component surfaces may be textured in such a way that magnetic attraction is manipulated to suit the end-use application of the inventive floor mat.

As discussed previously, the magnetic particles may be incorporated into the floor mat of the present invention either by applying a magnetic coating to floor-facing surface of the textile component or by including the particles in the rubber material of the textile material and/or the base component prior to vulcanization. When incorporation is via a magnetic coating, a binder material is generally included. Thus, the magnetic coating is typically comprised of at least one type of magnetic particles and at least one binder material.

The binder material is typically selected from a thermoplastic elastomer material and/or a thermoplastic vulcanite material. Examples include urethane-containing materials, acrylate-containing materials, silicone-containing materials, and mixtures thereof. Barium ferrites, strontium ferrites, neodymium and other rare earth metal based alloys can be mixed with the appropriate binder to be coated on the textile and/or base component.

In one aspect, the binder material will exhibit at least one of the following properties: (a) a glass transition (T_{g}) temperature of less than 10° C.; (b) a Shore A hardness in the range from 30 to 90; and (c) a softening temperature of greater than 70° C.

In one aspect, an acrylate and/or urethane-containing binder system is combined with Fe₃O₄ to form the magnetic coating of the present invention. The ratio of Fe₃O₄: acrylate and/or urethane binder is in the range from 40-70%: 60:30% by weight. The thickness of the magnetic coating may be in the range from 10 mil to 40 mil. Such a magnetic coating exhibits flexibility without any cracking issues.

Following application or inclusion of the magnetic particles into the textile and/or base component, the particles need to be magnetized. Magnetization can occur either during the curing process or after the curing process. Curing is typically needed for the binder material that is selected and/or for the rubber material that may be selected.

During the curing process, the magnetizable particles are mixed with the appropriate binder and applied via a coating technique on the substrate to be magnetized. Once the coating is complete, the particles are magnetized in the presence of external magnets during the curing process. The component that contains the magnetic particles is exposed to a magnetic field which aligns the dipoles of magnetic particles, locking them in place until the binder is cured. The magnetic field is preferably installed in-line as part of the manufacturing process. However, the magnetic field may exist as a separate entity from the rest of the manufacturing equipment.

Alternatively, the magnetic particles may be magnetized after the curing process. In this instance, the magnetizable particles are added to the binder material and applied to the textile and/or base component in the form of a film or coating. The film or coating is then cured. The cured substrate is then exposed to at least one permanent magnet. Exposure to the permanent magnet may be done via direct contact with the coated substrate or via indirect contact with the coated substrate. Direct contact with the permanent magnet may occur, for example, by rolling the permanent magnet over the coated substrate. The magnet may be rolled over the coated substrate a single time or it may be rolled multiple times (e.g. 10 times). The permanent magnet may be provided in-line with the manufacturing process, or it may exist separately from the manufacturing equipment. Indirect contact may include a situation wherein the coated substrate is brought close to the permanent magnet, but does not contact or touch the magnet.

Depending upon the pole size, strength and domains on the permanent magnet (or electromagnet), it can magnetize the magnetizable coating to a value between 10 and 5000 Gauss or a value close to the maximum Gauss value of the magnetizing medium. Once the coating is magnetized, it will typically remain permanently magnetized.

The washable floor mat of the present invention may be exposed to post treatment steps. For example, chemical treatments such as stain release, stain block, antimicrobial resistance, bleach resistance, and the like, may be added to the washable mat. Mechanical post treatments may include cutting, shearing, and/or napping the surface of the washable multi-component floor mat.

The performance requirements for commercial matting include a mixture of well documented standards and industry known tests. Tuft Bind of Pile Yarn Floor Coverings (ASTM D1335) is performance test referenced by several organizations (e.g. General Services Administration). Achieving tuft bind values greater than 4 pounds is desirable, and greater than 5 pounds even more desirable.

Resistance to Delamination of the Secondary Backing of Pile Yarn Floor Covering (ASTM D3936) is another standard test. Achieving Resistance to Delamination values greater than 2 pounds is desirable, and greater than 2.5 pounds even more desirable.

Pilling and fuzzing resistance for loop pile (ITTS112) is a performance test known to the industry and those practiced in the art. The pilling and fuzzing resistance test is typically a predictor of how quickly the carpet will pill, fuzz and prematurely age over time. The test uses a small roller covered with the hook part of a hook and loop fastener. The hook material is Hook 88 from Velcro of Manchester, N.H. and the roller weight is 2 pounds. The hook-covered wheel is rolled back and forth on the tufted carpet face with no additional pressure. The carpet is graded against a scale of 1 to 5. A rating of 5 represents no change or new carpet appearance. A rating of less than 3 typically represents unacceptable wear performance.

An additional performance/wear test includes the Hexapod drum tester (ASTM D-5252 or ISO/TR 10361 Hexapod Tumbler). This test is meant to simulate repeated foot traffic over time. It has been correlated that a 12,000 cycle count is equivalent to ten years of normal use. The test is rated on a gray scale of 1 to 5, with a rating after 12,000 cycles of 2.5=moderate, 3.0=heavy, and 3.5=severe. Yet another performance/wear test includes the Radiant Panel Test. Some commercial tiles struggle to achieve a Class I rating, as measured by ASTM E 648-06 (average critical radiant flux>0.45=class I highest rating).

The textile component of the floor mat may be washed or laundered in an industrial, commercial or residential washing machine. Achieving 200 commercial washes on the textile component with no structural failure is preferred.

Test Methods

Peel Test: The T-peel test was conducted on an MTS tensile tester at a speed of 12 inch/min. One end of the same (preferably the rubber side) was fixed onto the lower jaw and the fabric was fixed onto the upper jaw. The peel strength of the fabric from the rubber was measured from the average force to separate the layers. A release liner was added on the edge of the sample (a half an inch) between the fibers and the rubber to facilitate the peel test.

The peel strength measured in the above test indicates the force required to separate the single fiber, or unidirectional array of fibers from the rubber. In all the experiments, the array of fibers is pulled at 180 degrees to the rubber sample. In all samples the thickness of the rubber was approximately 3 mm.

### Examples

The invention will now be described with reference to the following non-limiting examples, in which all parts and percentages are by weight unless otherwise indicated.

In order to test the improvement in strength of the floor mat formed with a reinforcement layer, a control (non-reinforced) mat and a reinforced mat were each subjected to repeated loads well below their failure point. The final strains at the end of the test were used to provide a measure of rippling (or non-flatness).

A standard Lutradur® 5214 non-woven from Freudenberg USA tufted at 5/32″ gage with 8.5 stitches per inch (SDN tufting style) was used as the primary backing layer for the test. Various reinforcements (i.e. reinforcement layers) from 1 inch to 2 inches wide were placed along with additional rubber to form the textile component of the floor mat.

The textile component was cut into 6″ by 9″ coupons and fatigue tested on an Electro-Mechanical load testing frame at loads well below their failure for a fixed number of cycles. The strain in the sample at the end of the test is typically not recoverable and represents the extent of non-flatness (or rippling) in the textile component of the floor mat. A higher residual strain at the end of the test implies weaker textile-rubber composite.

Example 1 (“MilliCap® Reinforced”) was comprised of solution dyed nylon (“SDN”) face yarns tufted into the Lutradur® non-woven substrate as described above. A layer of rubber 50 mm wide and 1 mm thick was placed around the border of the textile area and within the textile. A reinforcement layer comprised of MilliCap® cap ply strips 0624 (available from Milliken & Company of Spartanburg, S.C.) was then placed on the rubber strip at 50 mm width. A sheet of rubber 0.635 mm thick was placed next and the assembly was vulcanized at 185° C. and 35 psi pressure for 4 minutes. A Millicap® reinforced textile component was thus produced and tested.

Example 2 (“Scrim Reinforced”) was comprised of nylon 6,6 face yarns tufted into the Lutradur® non-woven substrate as described above. A layer of rubber 50 mm wide and 1 mm thick was placed around the border of the textile area and within the textile. A knit reinforcement layer comprised of scrim material made using 500 denier polyester with 9 ends along both the machine and cross machine directions (available from Milliken & Company of Spartanburg, S.C.) was then added on the rubber strip at 50 mm width. A sheet of rubber 0.635 mm thick was placed next and the assembly was vulcanized at 185° C. and 35 psi pressure for 4 minutes. A scrim-reinforced textile component was thus produced and tested.

Comparative Example 1 (“Unreinforced”) was the same as Example 1, except that no reinforcements (i.e. reinforcement layers) were added.

Each of the samples was tested for fatigue and a load-strain curve was recorded. The test was performed at 35 pounds of force for 100 cycles of loading and un-loading. The resulting hysteresis curves are shown in FIG. 4.

The use of physical reinforcements (i.e. reinforcement layers) strengthens the textile-rubber composite of the textile component of the floor mat allowing it to withstand the loads in the laundry and during use with no permanent stretch observed, thus keeping it flat (exhibiting no rippling) throughout use.

Additional floor mats were made by laying a piece of tufted textile over an uncured rubber sheet and subjecting this combination to heat (185° C.) and pressure (35 psi) for 4 minutes, which is sufficient time for the rubber to completely vulcanize and bond to the textile.

Four different types of mats were made as follows:
Nitrile rubber (NBR) was used in all cases. The formulation used was very typical of the types used to make dust control mats, but with the addition of iron oxide filler to make the textile component magnetically attractive to the magnetized base component.
After mixing and calendaring the rubber into sheets of the desired thickness mats were made by laying the tufted textile component onto the rubber sheet and applying heat and pressure in the range from 2 to 15 minutes, typically in the range from 5 to 10 minutes.
The pressure applied is in the range from 5 to 50 psi, more preferably in the range from 15 to 30 psi.
The temperature applied is in the range from 120 to 200 degrees Celsius, more typically in the range from 140 to 190 degrees Celsius.
Type 1—Control: Just rubber sheet and textile
Type 2—Control 2: As Type 1 but includes a 50 mm wide non-reinforcing rubber strip around the edge of the rubber. This was placed between the textile and the main rubber sheet.
Type 3—Scrim Mat 1: As Type 2 but an additional 40 mm wide strip of “chafer” fabric was placed on top of the main rubber sheet under the 50 mm rubber strip. This fabric had been heat set at 170° C. for 5 minutes.
Type 4—Scrim Mat 2: As Type 3, but using the same fabric strip heat set at 200° C. for 5 minutes.
2 mats of each type were made, and after manufacture all the mats were completely flat and ripple free. They were then subjected to repeated washing and drying in an industrial laundry.
After 15 wash and dry cycles the number of ripples shown by each mat was counted when lying on the floor, and when lying on a magnetized mat base. The results are tabulated in Table 1 below:

TABLE 1
Effects of Repeated Laundering Cycles on Rippling of Floor Mat

| | | No of ripples | No of ripples |
|---|---|---|---|
| | | when laid on | when laid on a |
| Mat Type | Mat Number | floor | magnetic base |
| Type 1 Control | 1 | 29 | 16 |
| | 2 | 29 | 6 |
| Type 2 Control | 1 | 9 | 0 |
| | 2 | 9 | 0 |
| Type 3 Scrim Mat | 1 | 0 | 0 |
| 1 | | | |
| | 2 | 0 | 0 |
| Type 4 Scrim Mat | 1 | 2 | 0 |
| 2 | | | |
| | 2 | 0 | 0 |

Test results indicate that the presence of the rubber strip does help eliminate ripples when the mat is laid on the magnetic base. However, it is important that the mat appears ripple free before it is laid on the base. Although the rubber strip helps in this respect, it is only the presence of the additional scrim fabric that eliminates the ripples completely.

This partially beneficial effect of the rubber strip is exploited further in another aspect of the invention. The use of mat reinforcement to prevent rippling can be achieved by eliminating the textile and just using a rubber strip that has reinforcing properties of its own. This may be achieved by modifying the rubber compound formula to increase its tensile strength and resistance to tear. Methods of achieving this through rubber formulation are well known to those skilled in the art and all potential routes are covered in this invention. One example that has been shown to be very effective is to use a highly reinforcing carbon black filler in the rubber such as HAF Black (N330) in place of the more common semi-reinforcing carbon black—SRF Black (N550). In another case, reinforcing fillers can be added to the rubber compound formulation to increase the tensile and tear strength of the compound. Examples of such fillers are the glass fiber and glass flake materials sold by the NSG Group under various trade names.

Several specific floor mat constructions that have been shown to provide a beneficial effect on floor mat rippling after washing include:
1) Full sheet on back or under textile: A sheet of reinforcing textile can be applied over the whole mat surface. This may be located between the tufted textile and the rubber base, or on the opposite side of the rubber base to the tufted textile. In the former case the presence of the reinforcing textile may inhibit the bond between the tufted textile and the rubber. This is avoided in the latter case, but the reinforcing textile may still be visible after the mat pressing process.
2) Picture frame on back or under textile: Rippling occurs around the edges of the mat and it has been found that this can be minimized or eliminated by just using a border of reinforcing textile around the edge of the mat. The width of this border may be in the range from 5 mm to 200 mm, more preferably in the range from 10 mm to 100 mm, and most preferably in the range from 20 mm to 70 mm. As in construction 1) above, this reinforcing textile can be placed between the tufted textile and the rubber, or on the other side of the rubber backing. However, the presence of the reinforcing textile may inhibit the bond between tufted textile and rubber, or be visible on the finished mat.
3) Picture frame plus rubber on back: It is preferred to use a frame of reinforcing textile as described in 2) above on the underside of the rubber backing, and to then cover this textile with strips of rubber prior to pressing the mat. In this way the reinforcing textile does not interfere with the bond between the tufted textile and the rubber backing, and the reinforcing textile is not visible to the human eye.
4) Picture frame plus rubber under textile: In the most preferred construction, a frame of reinforcing textile as described in 2) above is laid around the edge of the mat and then covered by a rubber strip before the tufted textile top is placed on top and the mat pressed as per the normal manufacturing process. This construction is preferred for several reasons: 1) Mat lay-up prior to pressing is easier and quicker to perform, 2) The presence of a rubber strip between the reinforcing textile and the back of the tufted textile ensures that a good bond is achieved between rubber backing and the tufted textile, and 3) Testing has shown that this construction is the most beneficial in preventing floor mat rippling after washing and drying.

Thus, the present invention provides a useful advance over prior art floor mats by providing a solution to the detrimental effects caused by exposure of the floor mat to laundering cycle(s) which result in permanent deformation and rippling of the floor mat.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the subject matter of this application (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter of the application and does not pose a limitation on the scope of the subject matter unless otherwise claimed. No language in the specification should be construed as indicating any non-claimed element as essential to the practice of the subject matter described herein.

Preferred embodiments of the subject matter of this application are described herein, including the best mode known to the inventors for carrying out the claimed subject matter. Variations of those preferred embodiments may become apparent to those of ordinary skill in the art upon reading the foregoing description. The inventors expect skilled artisans to employ such variations as appropriate, and the inventors intend for the subject matter described herein to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the present disclosure unless otherwise indicated herein or otherwise clearly contradicted by context.

We claim:

1. A lightweight, single-piece floor mat comprising:
(a) A textile component having a floor-facing surface and a non-floor facing surface, said textile component comprising: (i) a layer of tufted pile carpet formed by tufting face fibers through a primary backing layer, and (ii) a reinforcement layer, wherein the reinforcement layer includes at least one of a textile substrate and an elastomeric material; and
(b) A base component comprised of elastomeric material; and
wherein the textile component and the base component are permanently attached to one another;
and wherein the single-piece floor mat can withstand at least one wash cycle in a commercial or residential washing machine and is suitable for re-use after exposure to the at least one wash cycle.
